(19) United States
(12) Patent Application Publication
(10) Pub. No.: US 2009/0051733 A1
(43) Pub. Date: Feb. 26, 2009

(54) EFFICIENT IMAGE ARRAY MICRO ELECTROMECHANICAL SYSTEM (MEMS)JET

(75) Inventors: Donald Drake, Rochester, NY (US); Peter Nystrom, Webster, NY (US)

Correspondence Address: MH2 TECHNOLOGY LAW GROUP, LLP (CUST. NO. W/XEROX), 1951 KIDWELL DRIVE, SUITE 550, TYSONS CORNER, VA, 22182, US

(73) Assignee: Xerox Corporation

(21) Appl. No.: 11/842,613

(22) Filed: Aug. 21, 2007

(51) Int. Cl. B41J 2/145; B23P 17/00

(52) U.S. Cl. 347/40; 29/890.1

(57) ABSTRACT

An imaging array and method of forming an imaging array includes a plurality of staggered imaging dies formed as a row of alternating open spaces and imaging dies. A plurality of driver dies can be adaptively arranged in the open spaces formed by the staggered imaging dies. The use of the open spaces between the staggered imaging dies allows for a color imaging array that occupies a waterfront of approximately 20 mm.

### FIELD

The subject matter of the teachings disclosed herein relates to print heads. More particularly, the subject matter of the teachings disclosed herein relates to an imaging array.

### BACKGROUND

One of the difficult constraints associated with an imaging array is to provide a reasonable nozzle density while minimizing the print head in the drum motion direction, called waterfront. The reason for this constraint is that the curvature of the drum on which the drops are printed creates different flight distances and arrival times for the drops from different nozzle arrays in a four color print head. Unless the nozzle arrays are close together, the resulting image will have defects. Exacerbating this issue is the fact that most printing arrays composed of subunits choose to stagger the subunits to avoid the difficult issues entailed in tightly butting the subunits. While the staggered architecture avoids the butting issues, it exacerbates the issue of waterfront, since the depth of the imaging array must now be at least twice the depth of a single die.

FIG. 1 shows a conventional, single color staggered imaging array 100. In particular, a conventional staggered imaging array 100 relying on micro electromechanical system (MEMS) technology includes staggered MEMS dies 110a-110d and associated driver dies 120a-d.

Driver die 120a provides driver functionality for MEMS die 110a. Driver die 120b provides driver functionality for MEMS die 110b. Driver die 120c provides driver functionality for MEMS die 110c. Driver die 120d provides driver functionality for MEMS die 110d.

MEMS dies 110a and 110b are slightly staggered with respect to one another to double the resolution as compared to use of an individual MEMS die 110b. For example, if the nozzle resolution of die 110a is 150 nozzles per inch, the resolution of the slightly staggered pair 110a and 110b is 300 nozzles per inch. MEMS dies 110c and 110d are slightly staggered with respect to one another to double the resolution as compared to use of an individual MEMS die 110c. MEMS die 110a and 110b can easily be combined into a single die with a fill slot in between the two arrays; likewise for die 110c and 110d. In any case, it is desirable for die 110a and 110b to be staggered relative to die 110c and 110d to avoid the difficult butting issues of trying to precisely and tightly butt die 110a and 110b with die 110c and 110d.

It would be desirable that the waterfront of the conventional staggered imaging array 100 is minimized, ideally no greater than the depth of the MEMS die 110a+110b+110c+110d=10 mm in this example. However, because the driver dies 120a and 120d must be arranged next to their respective MEMS dies 110a and 110d the resultant full depth of the conventional staggered imaging array from top to bottom is approximately 15 mm because it must include the added depth of the two driver die. In this example, the depth of the staggered imaging array is 15 mm, even though the depth of the MEMS die is only 10 mm. With space constraints (waterfront) inside of a printer device utilizing an imaging array 100 becoming increasingly more limited, a 15 mm depth for each conventional imaging array 100 can become a relevant design constraint.

Accordingly, the present teachings solve these and other problems of the prior art's depth of an imaging array.

### SUMMARY

In accordance with the teachings, an imaging array is disclosed herein. The imaging array includes a plurality of staggered imaging dies to form a row of alternating open spaces and imaging dies, and a plurality of driver dies adaptively arranged in the open spaces formed by the staggered imaging dies.

In accordance with the teachings, a method of forming an imaging array is disclosed herein. The method of forming an imaging array includes staggering a plurality of imaging dies to form a row of alternating open spaces and imaging dies, and adaptively arranging a plurality of driver dies in the open spaces formed by the staggered imaging dies.

Additional advantages of the embodiments will be set forth in part in the description which follows, and in part will be obvious from the description, or may be learned by practice of the teachings. The advantages will be realized and attained by means of the elements and combinations particularly pointed out in the appended claims.

It is to be understood that both the foregoing general description and the following detailed description are exemplary and explanatory only and are not restrictive of the teachings, as claimed.

The accompanying drawings, which are incorporated in and constitute a part of this specification, illustrate embodiments of the teachings and together with the description, serve to explain the principles of the teachings.

### BRIEF DESCRIPTION OF THE DRAWINGS

FIG. 1 shows a conventional staggered imaging array.

FIG. 2 shows a portion of a staggered imaging array, in accordance with the principles of the present teachings.

FIG. 3 shows a portion of a staggered imaging array, in accordance with the principles of the present teachings.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the teachings disclosed herein are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

In accordance with the teachings disclosed herein, an imaging array architecture is disclosed that can provide for an efficient packing of a Micro ElectroMechanical System (MEMS)JET print die and driver die pair. Using a staggered arrangement of MEMS print dies for a staggered imaging array, an open space is created between the MEMS print dies. A driver chip is arranged in this open space without increasing the waterfront of the imaging array. An imaging array packaged in accordance with the principles disclosed herein can meet the stringent requirements of a printer architecture to pack four color arrays in the minimum waterfront.

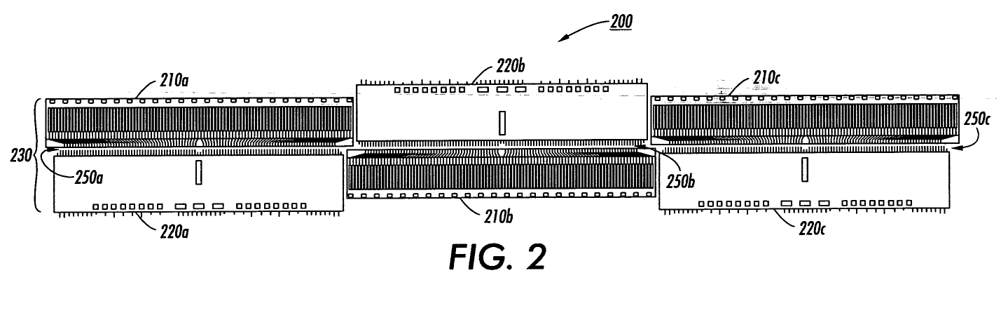

FIG. 2 shows a portion of a staggered imaging array 200, in accordance with the principles of the present teachings. It should be readily apparent to those of ordinary skill in the art that the staggered imaging array 200 shown in FIG. 2 represents a generalized system illustration and that other components can be added or existing components can be removed or modified while still remaining within the spirit and scope of the present teachings.

In particular, FIG. 2 shows a portion of a staggered imaging array 200 that can include MEMS dies 210a-c electrically coupled to respective driver dies 220a-c. Only a portion of the imaging array 200 is shown for simplification purposes only, with one of ordinary skill in the art understanding that the teachings disclosed herein applying to an imaging array of any width. Driver die 220a provides driver functionality for MEMS die 210a, driver die 220b provides driver functionality for MEMS die 210b, and driver die 220c provides driver functionality for MEMS die 210c.

Every other MEMS dies 210a and 210c along the top row of the staggered imaging array 200 is arranged with its electrical contacts on their respective bottom edge 250a and 250c. Likewise MEMS die 210b along the bottom row of the staggered imaging array 200 is arranged with its electrical contacts on its top edge 250b. Every other driver dies 220a and 220c along the bottom row of the staggered imaging array 200 can be arranged with its electrical contacts on their top edge 250a and 250c. Likewise driver die 220b along the top row of the staggered imaging array 200 can be arranged with its electrical contacts on its bottom edge 250b.

The MEMS dies 210a and 210c can overlap by a small margin with MEMS die 210b in a staggered imaging array 200, as shown in FIG. 2. Because of this small overlap, the open spaces formed between MEMS dies 220a-c can be smaller in width than any individual MEMS die 210a-c. To allow the driver dies 220a-c to be mounted in the open spaces created in a staggered imaging array 100, the driver dies 220a-c can be smaller in width than an individual MEMS die 210a-c. The driver dies 220a-c can be any width that allows for their arrangement in the open spaces 120a-c.

Thus, in accordance with the principles disclosed herein, driver dies 220a-c can be arranged in open areas created in a staggered arrangement for MEMS dies 220a-c. The waterfront created with the staggered imaging array 200 using alternating MEMS dies and driver dies in a horizontal axis can create a waterfront of approximately 5 mm. The staggered imaging array 200 can be used as a building block for forming an imaging array that includes higher resolutions and/or an imaging array that includes multiple colors.

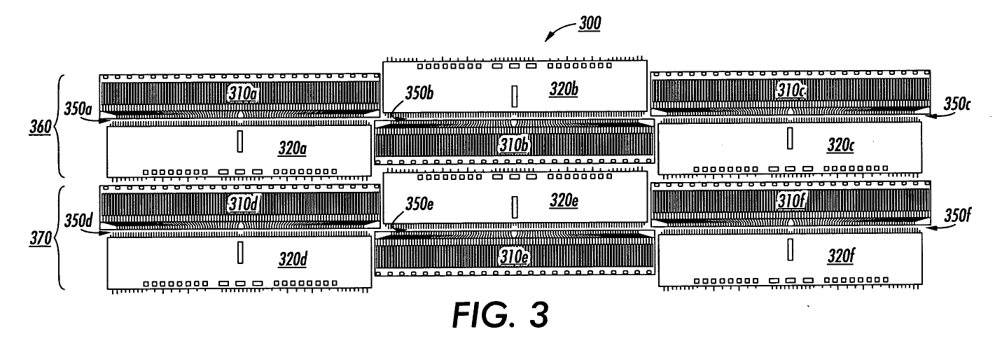

FIG. 3 shows a portion of a staggered imaging array 30, in accordance with the principles of the present teachings. It should be readily apparent to those of ordinary skill in the art that the imaging array 300 shown in FIG. 3 represents a generalized system illustration and that other components can be added or existing components can be removed or modified while still remaining within the spirit and scope of the present teachings.

In particular, FIG. 3 shows a portion of a staggered imaging array 300 that can include MEMS dies 310a-f electrically coupled to respective driver dies 320a-f. Only a portion of the imaging array 300 is shown for simplification purposes only, with one of ordinary skill in the art understanding that the teachings disclosed herein applying to an imaging array of any width. Staggered imaging array 300 can include upper MEMS dies 310a-c and driver dies 320a-c pairs 360 and lower MEMS dies 310d-f and driver dies 320d-f pairs 370. Driver die 320a provides driver functionality for MEMS die 310a, driver die 320b provides driver functionality for MEMS die 310b, driver die 320c provides driver functionality for MEMS die 310c, driver die 320d provides driver functionality for MEMS die 310d, etc.

Every other MEMS die 310a and 310c, along the top row of the upper MEMS dies 310a-c and driver dies 320a-c pairs 360 can be arranged with its electrical contacts on their respective bottom edge 350a and 350c. Likewise, MEMS die 310b along the bottom row of the upper MEMS dies 310a-c and driver dies 320a-c pairs 360 can be arranged with its electrical contacts on its top edge 350b. Every other driver die 320a and 320c along the bottom row of the upper MEMS dies 310a-c and driver dies 320a-c pairs 360 can be arranged with its electrical contacts on their respective top edges 350a and 350c. Likewise driver die 320b along the top row of the upper MEMS dies 310a-c and driver dies 320a-c pairs 360 can be arranged with its electrical contacts on its bottom edge 350b.

Every other MEMS die 310d and 310f, along the top row of the lower MEMS dies 310d-f and driver dies 320d-f pairs 370 can be arranged with its electrical contacts on their respective bottom edge 350d and 350f. Likewise, MEMS die 310e along the bottom row of the lower MEMS dies 310d-e and driver dies 320d-f pairs 370 can be arranged with its electrical contacts on its top edge 350e. Every other driver die, 320d and 320f along the bottom row of the lower MEMS dies 310d-f and driver dies 320d-f pairs 370 can be arranged with its electrical contacts on their respective top edges 350d and 350f. Likewise driver die 320e along the top row of the lower MEMS dies 310d-f and driver dies 320d-f pairs 370 can be arranged with its electrical contacts on its bottom edge 350e.

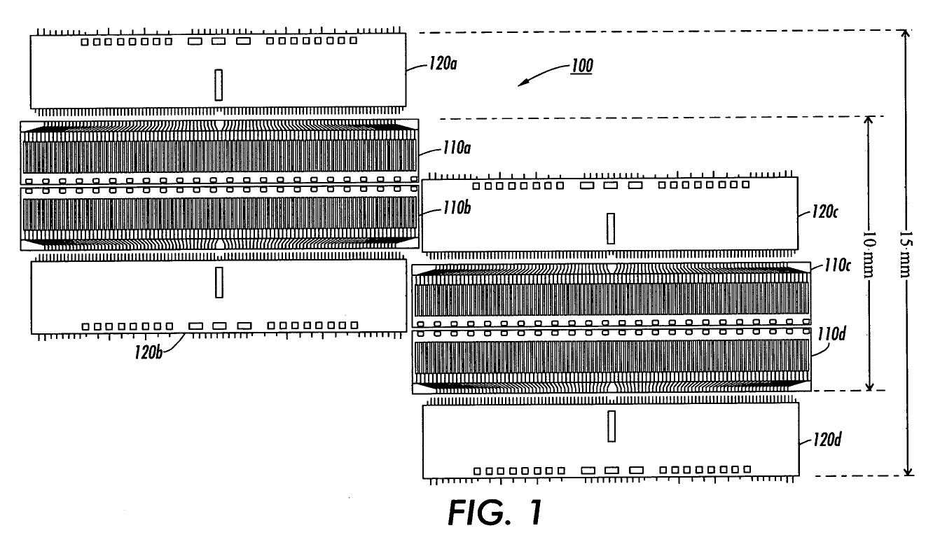

Thus, In accordance with the principles disclosed herein driver dies 320a-f are arranged in the open areas created in the staggered layout of MEMS dies 410a-f. The waterfront created with the staggered imaging array 200 using alternating MEMS dies and driver dies along a horizontal axis can create a waterfront of approximately 10 mm. When comparing the conventional arrangement shown in FIG. 3 with the exemplary embodiment depicted in FIG. 1, both have equivalent nozzle resolution. However, the architecture of the exemplary embodiment depicted in FIG. 1 consumes 15 mm of depth while the conventional arrangement shown in FIG. 3 only consumes 10 mm of depth so the architecture of the exemplary embodiment depicted in FIG. 3 is significantly more efficient in waterfront. The architecture of the exemplary embodiment depicted in FIG. 3 achieves the desired objective of minimizing the waterfront to just the combined depth of the staggered MEMS die; that is, there is no depth penalty for the driver die.

The staggered imaging array disclosed herein (with separate driver die) uses no more waterfront than a staggered imaging array that relies on MEMS dies with integrated driver electronics. Moreover, the decoupling of the driver dies from the MEMS dies decouples their respective yields. An exemplary yield for individual MEMS dies can be 70%, i.e., 30% of MEMS dies manufactured are defective and not suitable for inclusion into a printing device. An exemplary yield for individual driver dies can be 70%, i.e., 30% of driver dies manufactured are defective and not suitable for inclusion into a printing device. The resultant yield for an integrated solution would be the product of the two yields, i.e., 49% of integrated MEMS die/driver die combination would be suitable for inclusion into a printing device. The teachings disclosed herein produce higher yields than an integrated MEMS die/driver die solution.

Although the teachings disclosed herein exemplarily illustrate a staggered imaging array that relies on MEMS technology, one of ordinary skill in the art would recognize that the teachings disclosed herein can apply to a staggered imaging array that relies on any imaging technology. For example, the individual imaging dies can be a piezo-electric imaging die, light emitting diode (LED) imaging die, thermal imaging die, etc.

The imaging arrays 200 and 300 disclosed herein can be use for any width imaging array. The imaging arrays 200 and 300 can be less than a width of an imaging medium, e.g., a width of a paper. The imaging arrays 200 and 300 can be used to form a full width imaging array to print an entire width of an imaging medium at a time.

While the teachings disclosed herein have been illustrated with respect to one or more implementations, alterations and/or modifications can be made to the illustrated examples without departing from the spirit and scope of the appended claims. In addition, while a particular feature of the teachings disclosed herein may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings disclosed herein will be apparent to those skilled in the art from consideration of the specification and practice of the teachings disclosed herein. It is intended that the specification and examples be considered as exemplary only, with a true scope and spirit of the teachings disclosed herein being indicated by the following claims.

What is claimed is:

1. An imaging array, comprising:
a plurality of staggered imaging dies to form a row of alternating open spaces and imaging dies; and
a plurality of driver dies adaptively arranged in the open spaces formed by the staggered imaging dies.

2. The imaging array according to claim 1, further comprising a second row of staggered imaging dies.

3. The imaging array according to claim 1, wherein a width of an individual driver die from the plurality of driver dies is less than a width of an individual imaging die from the plurality of imaging dies.

4. The imaging array according to claim 1, wherein the imaging dies are color imaging dies.

5. The imaging array according to claim 1, wherein the plurality of imaging dies are micro-mechanical system (MEMS) imaging dies.

6. The imaging array according to claim 1, wherein the imaging dies are piezo-electric imaging dies.

7. The imaging array according to claim 1, further comprising a circuit board to provide a mounting surface for the plurality of imaging dies and the plurality of driver dies.

8. The imaging array according to claim 1, wherein a waterfront of the plurality of imaging dies and the plurality of driver dies is approximately 5 mm.

9. The imaging array according to claim 4, wherein a waterfront of the plurality of color imaging dies and the plurality of driver dies is approximately 20 mm.

10. A method of forming an imaging array, comprising:
staggering a plurality of imaging dies to form a row of alternating open spaces and imaging dies; and
adaptively arranging a plurality of driver dies in the open spaces formed by the staggered imaging dies.

11. The method of forming an imaging array according to claim 10, further comprising forming a second row of staggered imaging dies.

12. The method of forming an imaging array according to claim 10, further comprising forming a color imaging array from the plurality of imaging dies.

13. The method of forming an imaging array according to claim 10, wherein the plurality of imaging dies are micro-electromechanical system (MEMS) imaging dies.

14. The method of forming an imaging array according to claim 10, wherein the imaging dies are piezo-electic imaging dies.

15. The method of forming an imaging array according to claim 10, further comprising providing a circuit board, the circuit board providing a mounting surface for the plurality of imaging dies and the plurality of driver dies.

16. The method of forming an imaging array according to claim 10, further comprising forming the imaging array in a waterfront of approximately 5 mm.

17. The method of forming an imaging array according to claim 12, further comprising forming the color imaging array in a waterfront of approximately 20 mm.

18. The method of forming an imaging array according to claim 10, wherein a width of an individual driver die from the plurality of driver dies is less than a width of the an individual imaging die from the plurality of imaging dies.
